(19) United States
(12) Patent Application Publication
(10) Pub. No.: US 2008/0190695 A1
(43) Pub. Date: Aug. 14, 2008

(54) Hang on hunting blind

(76) Inventor: Harold Walden Blankenship, Lexington, TN (US)

Correspondence Address: Harold Walden Blankenship, 2820 Shadyhill Road, Lexington, TN, 38351, US

(21) Appl. No.: 11/706,388

(22) Filed: Feb. 14, 2007

(51) Int. Cl. A01M 31/02

(52) U.S. Cl. 182/187

(57) ABSTRACT

I, Harold Walden Blankenship, have invented a new idea for a hunting blind, as set forth in the following specification. The claimed hunting blind is used to hunt or view wildlife hanging on a tree.

### STATEMENT REGARDING FEDERALLY SPONSORED RESEARCH OR DEVELOPMENT

“Not Applicable”

### REFERENCE TO SEQUENCE LISTING, A TABLE OR A COMPUTER PROGRAM LISTING COMPACT DISC APPENDIX

“Not Applicable”

### BACKGROUND OF THE INVENTION

Stands used for deer hunting.

### BRIEF SUMMARY OF THE INVENTION

The advantage of this stand; the stand will hang on a tree and does not have to have a tripod stand for elevation.

### BRIEF DESCRIPTION OF THE SEVERAL VIEWS OF THE DRAWING

FIG. 1

Hunting Blind installed

FIG. 2

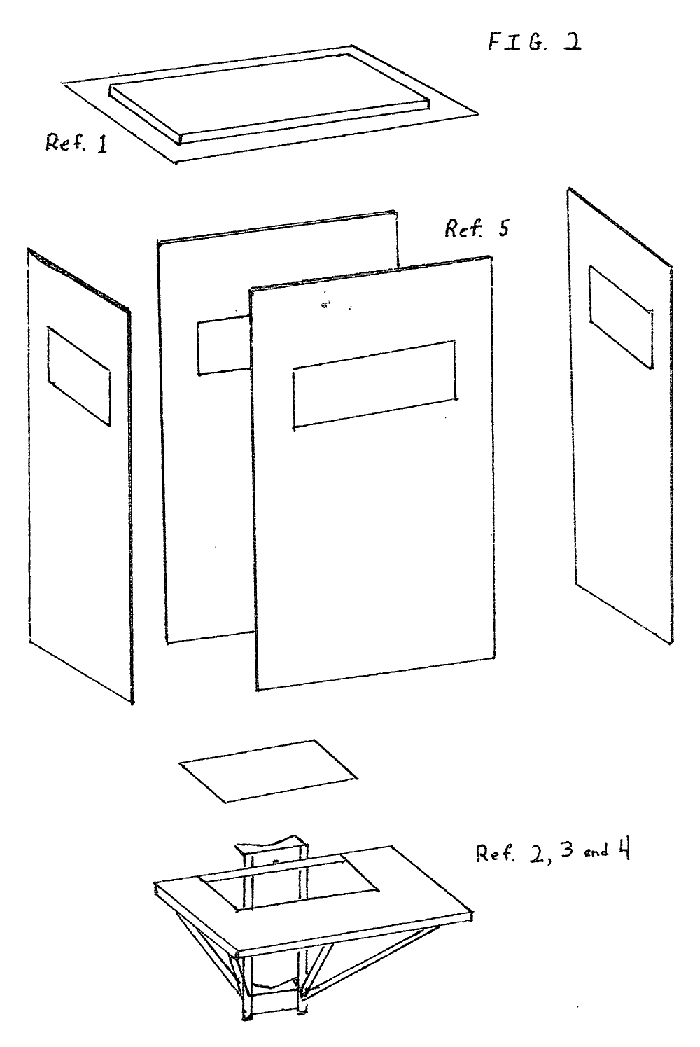

Breakdown of entire blind

FIG. 3

Side view of blind on tree

FIG. 4

Reference 1 Roof

Reference 2 Floor and trap door

Reference 3 Hang on platform

Reference 4 Six inch steel screw with ‘T’ design

FIG. 5

Reference 5 Wall (all identical)

Reference 6 seat

### DETAILED DESCRIPTION OF THE INVENTION

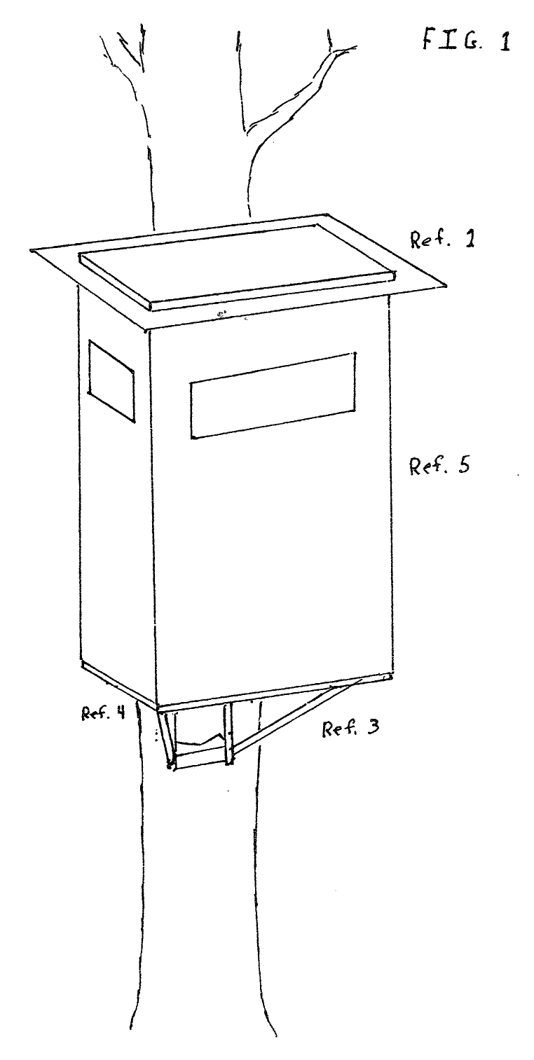

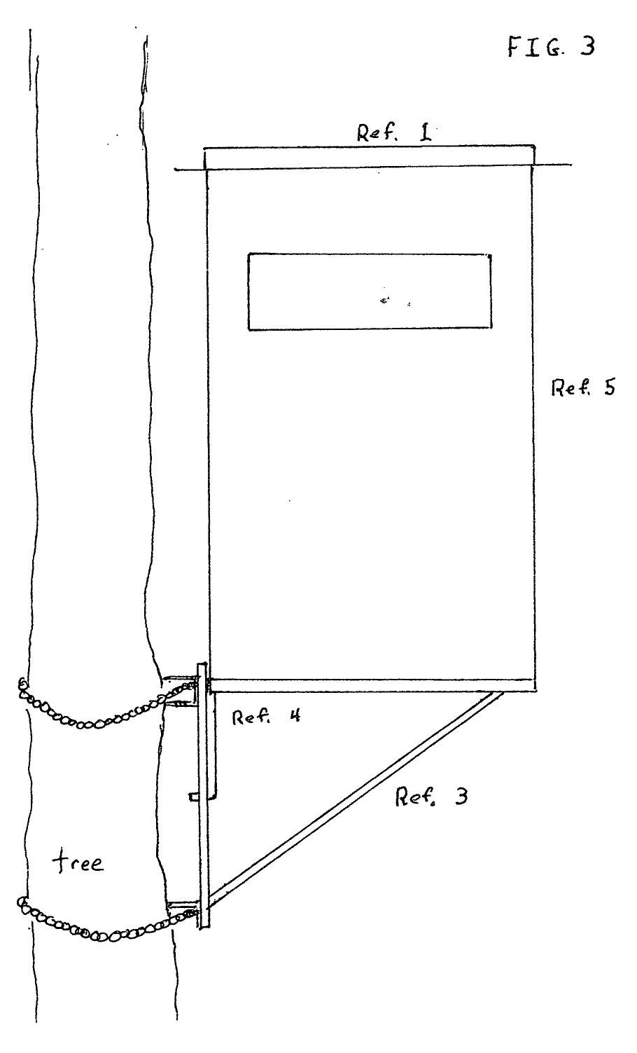

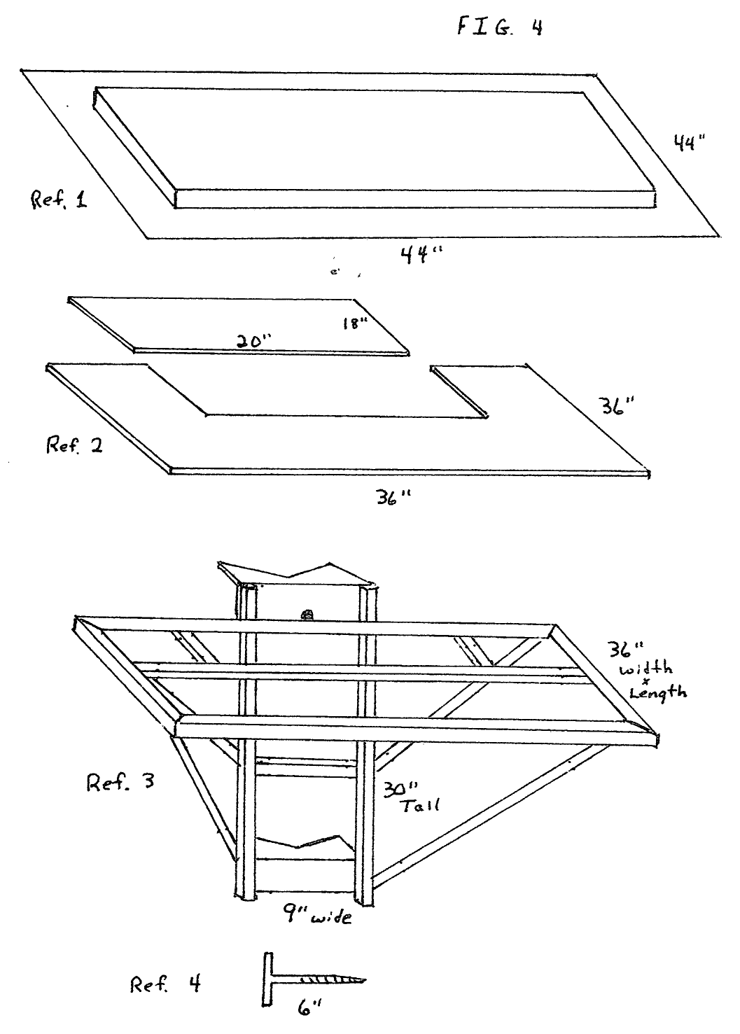

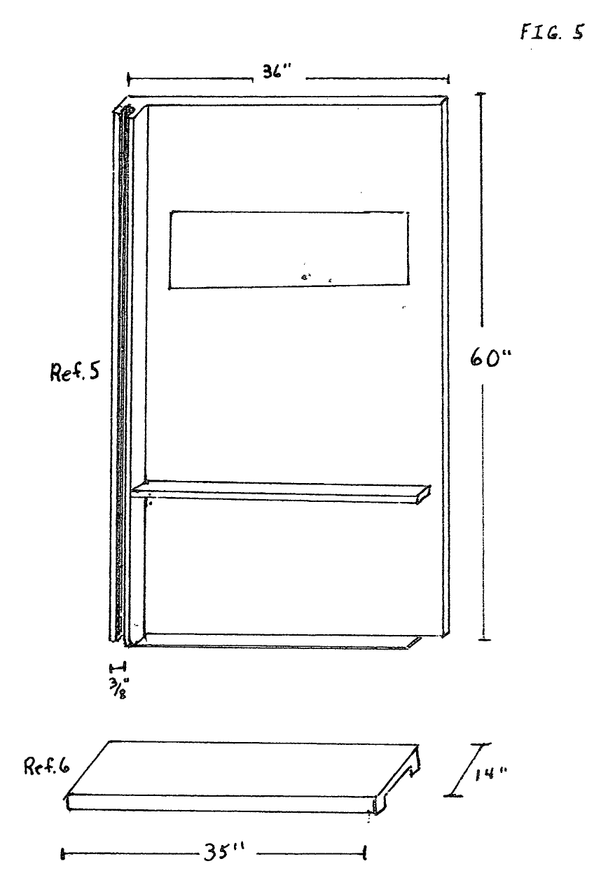

Hang on treestand for hunting, with walls and roof. (FIG. 1) Treestand is able to be hung at height from three feet to your chosen height using a varity of tree steps or ladder sticks. The stand platform is made of steel or aluminum (FIG. 4; Ref. 3) and is cut and welded together. The platform is thirty-six inches wide and thirty-six inches long with ⅜ inch flooring (FIG. 4; Ref. 2) securly fastened. A trap door through floor to enter. (FIG. 4; Ref. 2) Then stand platform is hung on tree using a six inch steel ‘T’ bar screw. (FIG. 4; Ref. 4) Then secured on tree with chains top and bottom of stand platform. (FIG. 3) Four walls sixty inches tall and thirty-six inches wide made of platic ⅜ inch thick (FIG. 5; Ref.5) are then pulled up one at a time, secured to platform and each other with screws. Roof, made of ¼ inch plastic (FIG. 4: Ref. 1) to be installed last. The roof installs over walls like a cap then secured with screws through walls. (FIG. 3; Ref. 1) Seat (FIG. 5; Ref. 6) sets on ledges in walls. Ready to use. (FIG. 1)

1. I, Harold Walden Blankenship, claim a new idea for a hunting blind. There is not a Hang On Blind with hard walls and roof on the market.
